(19) United States
(12) Patent Application Publication
(10) Pub. No.: US 2009/0038745 A1
(43) Pub. Date: Feb. 12, 2009

(54) Method for making three dimensional convex patterns

(75) Inventor: Meng-Chieh Lin, Feng-Yuan City (TW)

Correspondence Address: Mr. Phillip LIU, 6980, Whiteoak Dr., Richmond, BC, V7E 4Z9, CA

(73) Assignees: CHANG WANG INDUSTRIAL CO., LTD., FENG-YUAN CITY (TW); EVA-GLORY INDUSTRIAL CO., LTD., TANZIH TOWNSHIP (TW)

(21) Appl. No.: 11/882,767

(22) Filed: Aug. 6, 2007

(51) Int. Cl. B29C 59/00; B44C 1/00

(52) U.S. Cl. 156/219; 156/277

(57) ABSTRACT

A method for making three dimensional convex patterns on foam material includes a step of preparing a first netted fabric which includes first holes, a step of spreading a layer of ink on the first netted fabric, a step of overlapping the first netted fabric on a second netted fabric which includes second holes larger than the first holes, and a step of printing the layer of ink on a foam material by a molding set.

### FIELD OF THE INVENTION

The present invention relates to a method for making three dimensional convex patterns on foam material.

### BACKGROUND OF THE INVENTION

Conventional yoga pads or resilient floor are made by foam material which is flexible and absorbs shocks and noise. Some resilient floor includes serrated top surface so as to prevent users from slippery when walking on the floor. The serrated top surface is made by spreading a netted fabric on the heated foam material which is deformed by the netted fabric so that the longitudinal and altitude yarns press the deformed foam material to form the serrated top surface. A proper mold set is used to fix the serrated top surface.

However, the conventional method for making the convex patterns on the foam material can only create a simple and boring serrated top surface which cannot attract users' attention. In other words, the conventional method cannot create a foam product with esthetic feature.

The present invention intends to provide a method for making three dimensional convex patterns on foam material, the convex patterns include different grooves and printed colorful patterns by way of heat transfer printing.

### SUMMARY OF THE INVENTION

The present invention relates to a method for making three dimensional convex patterns on foam material and the method comprises the following steps:

a step of preparing a first netted fabric which includes first holes;

a step of spreading a layer of ink on the first netted fabric;

a step of overlapping the first netted fabric on a second netted fabric which includes second holes larger than the first holes, and

a step of printing the layer of ink on a foam material by a molding set.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the molding set, the foam material, the first netted fabric and the second netted fabric of the method of the present invention;

FIG. 2 shows the top surface of the foam material which includes three dimensional patterns made by the method of the present invention;

FIG. 3 is a cross sectional view to show the three dimensional patterns made by the method of the present invention, and

FIG. 4 shows steps of the method of the present invention.

### DETAILED DESCRIPTION OF THE PREFERRED EMBODIMENT

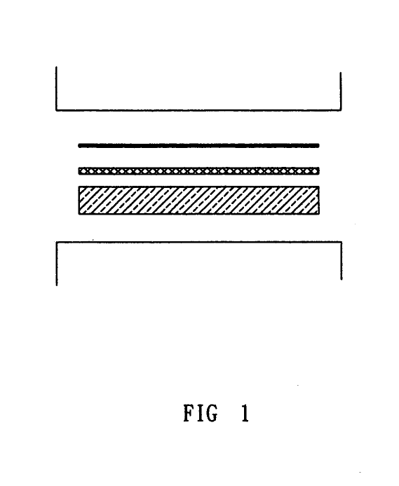

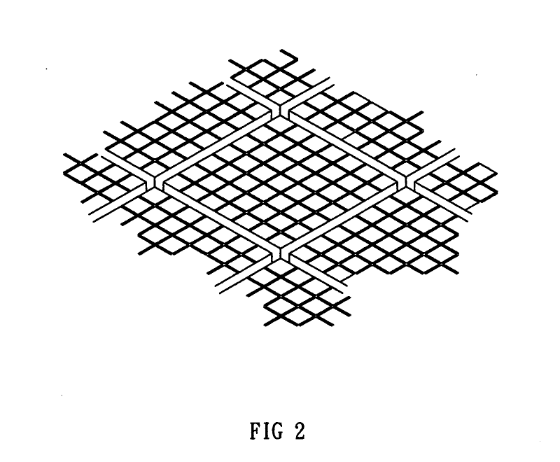

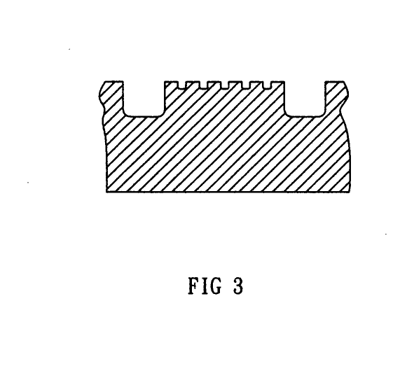

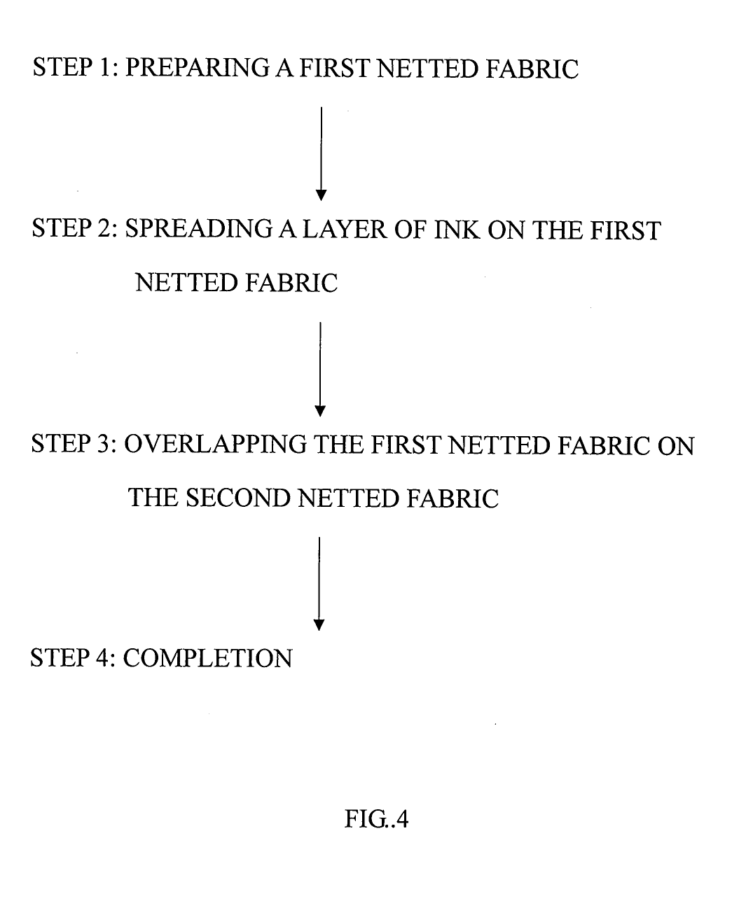

Referring to FIGS. 1 to 4, the method for making three dimensional convex patterns on foam material comprises the following steps:

a step of preparing a first netted fabric 10 which includes first holes;

a step of spreading a layer of ink 20 on the first netted fabric 10 whose longitudinal and altitude yarns are soaked with the ink 20;

a step of overlapping the first netted fabric 10 on a second netted fabric 30 which includes second holes 31 which are larger than the first holes, and

a step of printing the layer of ink 20 on a foam material 1 by a molding set.

The molding set includes a fixed part 41 and a movable part 40, the first netted fabric 10, the second netted fabric 30 and the foam material 1 are located between the fixed part 41 and the movable part 40 as shown in FIG. 1. The movable part 40 moves toward the fixed part 41 to press the first and second netted fabrics 10, 30 onto the foam material 1. The foam material 1 includes a first side and a second side, and at least one of the first and second sides is defined with first grooves 3 by pressing the first netted fabric 10 to the foam material 1, and second grooves 2 by pressing the second netted fabric 30 to the foam material 1. The first grooves 3 are shallow grooves and the second grooves 2 are deep grooves. Proper temperature is provided during the pressing so that the ink 20 is printed on a surface defining the first grooves 31 so as to form a printed layer 4. Therefore, the serrated top surface of the foam material made by the method of the present invention is provided with different colors or patterns.

The deeper second grooves 2 cooperated with the printed and shallow first grooves 3 increase the attraction to users and the three dimensional serrated top surface can be focused.

The foam material 1 can be Ethylene Vinyl Acetate (EVA), Polyethylene (PE), Polyurethane (PU), Thermoplastic Rubber TPR or rubber.

While we have shown and described the embodiment in accordance with the present invention, it should be clear to those skilled in the art that further embodiments may be made without departing from the scope of the present invention.

What is claimed is:

1. A method for making three dimensional convex patterns on foam material. comprising:
a step of preparing a first netted fabric which includes first holes;
a step of spreading a layer of ink on the first netted fabric;
a step of overlapping the first netted fabric on a second netted fabric which includes second holes larger than the first holes, and
a step of printing the layer of ink on a foam material by a molding set.

2. The method as claimed in claim 1, wherein the foam material is EVA, PE, PU, TPR or rubber.

3. The method as claimed in claim 1, wherein the foam material includes a first side and a second side, at least one of the first and second sides is defined with first grooves by pressing the first netted fabric to the foam material, and second grooves by pressing the second netted fabric to the foam material, the layer of ink is printed on a surface defining the first grooves.

4. The device as claimed in claim 3, wherein the foam material is EVA, PE, PU, TPE or rubber.
